(19) United States
(12) Patent Application Publication
(10) Pub. No.: US 2014/0100877 A1
(43) Pub. Date: Apr. 10, 2014

(54) HEALTHCARE FACILITY NAVIGATION METHOD AND SYSTEM

(71) Applicants: Kenneth Wayne RENNICKS, Pearland, TX (US); David Powell TAYLOR, Spring, TX (US); John SMITH, Houston, TX (US); James Patrick Herlihy, Houston, TX (US); John Christopher JOE, Houston, TX (US)

(72) Inventors: Kenneth Wayne RENNICKS, Pearland, TX (US); David Powell TAYLOR, Spring, TX (US); John SMITH, Houston, TX (US); James Patrick Herlihy, Houston, TX (US); John Christopher JOE, Houston, TX (US)

(21) Appl. No.: 14/046,463

(22) Filed: Oct. 4, 2013

Related U.S. Application Data
(60) Provisional application No. 61/709,454, filed on Oct. 4, 2012.

(51) Int. Cl. G06Q 50/22; G06Q 90/00

(52) U.S. Cl. CPC G06Q 50/22; G06Q 90/20
USPC 705/3; 705/2

(57) ABSTRACT

Techniques are disclosed for helping users navigate healthcare facilities. In one embodiment, a patient at a healthcare facility downloads a healthcare support application onto his or her handheld device. The healthcare support application may include content for orienting the patient and helping the patient to make informed decisions, as well content which allows the patient to provide feedback. Additional, personalized content may be provided by a surveillance interface based on a status of the patient. The surveillance interface may include a listening application which detects changes in electronic health records (EHR) related to the patient, and a surveillance application which cross-matches the changes to relevant content, organizes and/or generates personalized content from the relevant content, and pushes the personalized content to the healthcare support application.

### CROSS-REFERENCE TO RELATED APPLICATIONS

This Application claims benefit of U.S. Provisional Patent Application Ser. No. 61/709,454 filed Oct. 4, 2012, which is incorporated herein by reference in its entirety.

### BACKGROUND OF THE INVENTION

1. Field of the Invention

Embodiments presented in this disclosure generally relate to computer software and, in particular, to a method and system for helping users to navigate healthcare facilities.

2. Description of the Related Art

Healthcare facilities can be foreign environments to those outside the medical field. Patients, family members, and friends who visit healthcare facilities and both in and outpatient care areas such as in a hospital are typically unfamiliar with the caregivers, tests, treatments, procedures, machines, etc. they encounter. Such visitors to these areas of healthcare facilities may become disoriented, experience high stress levels, and yet find themselves in the position of having to make major medical decisions.

One approach for orienting visitors in healthcare facilities and improving their decision-making involves distributing informational pamphlets at kiosks or by hospital personnel. However, this approach typically requires visitors to physically locate and pick up pamphlets. Moreover, paper pamphlets provide limited information that may not be tailored to individual patients. In addition to distributing paper pamphlets, healthcare facilities typically solicit feedback by having patients, family members, and friends complete paper surveys after their visits. Such paper surveys do not permit real-time feedback, so many problems cannot be resolved or mitigated as they arise in the immediate tense.

Recently, handheld devices, such as mobile phones and tablet computers, have evolved to provide sophisticated computing platforms, complete with display areas, touch-sensitive surfaces, and cameras, among other components. Further, the computing power of these devices has steadily increased, allowing sophisticated computing applications to be executed from the palm of one's hand.

### SUMMARY

One embodiment provides a method for assisting a user visiting a healthcare facility. The method generally includes continuously monitoring a status of the user visiting the healthcare facility, and organizing and/or generating personalized content relevant to the user's visit to the healthcare facility based on the monitored status of the user. Further, the method includes transmitting the personalized content to a handheld device of the user, where the content is accessible via an application configured to run on the handheld device. In addition, the method includes receiving and storing feedback relating to the user's visit to the healthcare facility, where the feedback is provided via the application.

Other embodiments include a computer-readable medium that stores instructions that enable a processing unit to implement one or more aspects of the disclosed method as well as a system configured to implement one or more aspects of the disclosed method.

### BRIEF DESCRIPTION OF THE DRAWINGS

So that the manner in which the above recited features can be understood in detail, a more particular description, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a system in which an embodiment may be implemented.

FIG. 2 illustrates an example of a handheld device, according to an embodiment.

FIG. 3 illustrates relationships between components of a healthcare facility navigation system, according to an embodiment.

FIG. 4 illustrates a method for assisting users visiting a healthcare facility, according to an embodiment.

FIGS. 5A-C illustrate example screen configurations of a healthcare support application for helping users navigate healthcare facilities and provide feedback, according to an embodiment.

### DETAILED DESCRIPTION OF EXEMPLARY EMBODIMENTS

Embodiments of the invention provide techniques for helping visitors navigate healthcare facilities and provide feedback on their experiences. As used herein, “healthcare facility” refers to any clinic, hospital, nursing home, surgery center, or other facility providing healthcare services. In one embodiment, a patient at a healthcare facility downloads a healthcare support application onto his or her handheld device. The healthcare support application may provide content for orienting the patient in the environment of the healthcare facility and helping the patient make informed decisions, as well as content which allows the patient to provide feedback. For example, the healthcare support application may permit the patient to access content for one or more of the categories of diseases and therapies, caregivers, physical environment, emotional support, logistics, and pharmaceuticals. Such content may include personalized content provided by a surveillance interface based on a status of the patient. In one embodiment, the surveillance interface may include a listening application which detects changes in electronic health records related to the patient, and a surveillance application which cross-matches the changes to relevant content, organizes and/or generates personalized content from the relevant content, and pushes the personalized content to the healthcare support application. In a particular embodiment, the electronic health records may store codes such as ICD-10 or diagnosis-related group (DRG) codes, and new codes being entered may be reported to the surveillance application. In response, the surveillance application may cross-match the codes with relevant content, organize and/or generate personalized content from the relevant content, and transmit the personalized content to the healthcare support application.

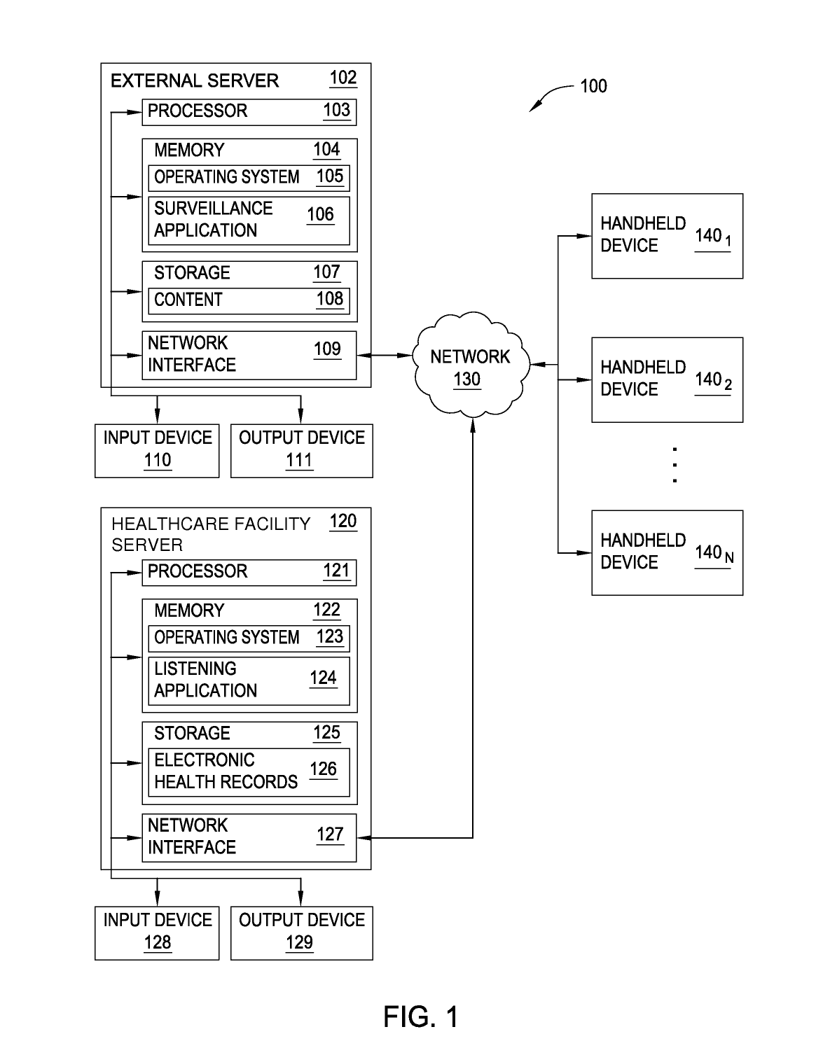

FIG. 1 is a block diagram of a system 100 in which an embodiment may be implemented. As shown, the system 100 includes computer server systems 102, 104, which are connected to each other and to handheld devices 140_{1-N} via a network 130. The network 130 may be a telecommunications network and/or a wide area network (WAN), such as the Internet.

Illustratively, the server systems 102, 120 include processors 103, 121 which are connected, respectively, via buses to memories 104, 122; network interface devices 109, 127; storage 107, 125; input devices 110, 128; and output devices 111, 129. As shown, the server systems 102, 120 are under the control of operating systems 105, 123, respectively. Examples of operating systems include the UNIX® operating system, versions of the Microsoft Windows® operating system, and distributions of the Linux® operating system. More generally, any operating system supporting the functions disclosed herein may be used. Processors 103, 121 are included to be representative of single CPUs, multiple CPUs, single CPUs having multiple processing cores, and the like. Memories 104, 122 may include random access memory. While the memories 106, 122 are shown as single units, it should be understood that each of the memories 106, 122 may comprise multiples modules, and that the memory 106 may exist at multiple levels, from high speed registers and caches to lower speed but larger DRAM chips. The network interface devices 109, 127 may be any type of network communications device allowing the server systems 102, 120 to communicate over the network 130.

The input devices 110, 128 may include any devices for providing input to the server systems 102, 120, respectively. For example, keyboards and/or mice may be used as input devices 110, 128. The output devices 111, 129 may include any devices for providing output to users of the server systems 102, 120, respectively. For example, the output devices 116, 129 may include conventional display screens and speakers. Although shown separately, output device 111 and input device 110, and output device 128 and input device 129, may be combined. For example, display screens with integrated touch-screens may be used.

As shown, the server 120 is a healthcare facility server. Among other things, electronic health records (EHR) 126 are stored in the server 120. EHR 126 may include any information related to the states of patients of the healthcare facility, such as medical history, immunization history, medications, allergies, personal statistics, family history, treatment plans, laboratory test results, radiology images, contact and billing information, insurance information, family member contact information, etc. For example, the healthcare facility may maintain a file containing such information for each patient who has visited the healthcare facility, and the EHR 126 may be continuously updated by staff during the normal course of operation of the healthcare facility. In some embodiments, standard codes may be stored in the EHR 126. Such codes may include ICD-10 codes, DRG codes, Acute Physiology and Chronic Health Evaluation (APACHE) score codes, and Sequential Organ Failure Assessment (SOFA) scores codes, among others.

Illustratively, the memory 106 of the healthcare facility server 120 includes a listening application 124. The listening application 124 is responsible for detecting changes in the EHR 126, as well as reporting such changes to a surveillance application 106, discussed below. For example, where ICD-10 or DRG codes are stored in the EHR 126, the listening application 124 may detect that additional code entries have been, or are being, added to a patient's record and transmit a message to the surveillance application 106 indicating the new entries. In one embodiment, the listening application may comply with the Health Level 7 (HL7) messaging standard, which uses a header that includes the following fields: field separator, encoding characters, message type, message control ID, processing ID, and version ID.

As shown, the server system 102 is a server external to the healthcare facility server 120. Although a single healthcare facility server 120 is shown, the external server 102 may generally be in communication with any number of healthcare facility servers. In another embodiment, the external server 102 may comprise multiple distinct physical servers. In a further embodiment, the external server 102 and the healthcare facility server 120 may be integrated into one server which performs the functionalities of both servers 102, 120. In yet another embodiment, one or both of the external server 102 and the healthcare facility server 120 may instead be hosted in a cloud computing environment, rather than being distinct physical servers.

As shown, memory 104 of the external server 102 includes a surveillance application 106, which is configured to receive messages (e.g., messages compliant with the HL7 messaging standard) indicating changes to a patient's status. For example, the surveillance application 106 may receive messages which include newly-entered ICD-10 or DRG codes in the EHR 126. Upon receiving such messages, the surveillance application 106 may cross-match the changes in the patient's status with content 108 stored in the external server's storage 107. Examples of content 108 may include educational content, media content, and pharmaceuticals content, discussed in greater detail below. Although shown as being stored in storage 107, in alternative embodiments, the content 108 may be stored elsewhere (e.g., on a content provider's server, from which the content 108 is retrieved).

The surveillance application 106 may organize and/or generate personalized content relevant to the patient's new status, and push such content to the patient's handheld device 140, as discussed in greater detail below. This continuing surveillance of the patient's electronic health record and organizing and/or generating of personalized content may result in regular reporting of relevant information about the patient's diagnosis and treatment, among other things, which may help decrease or eliminate frustrating miscommunications and better inform patients, who may need to make critical decisions.

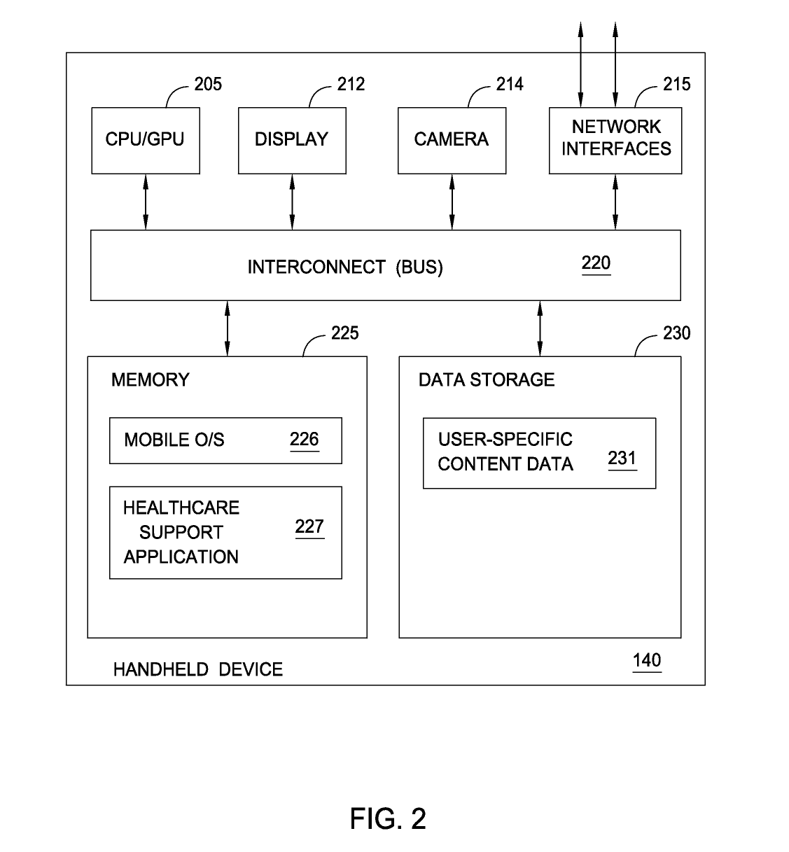

FIG. 2 further illustrates an example handheld device 140, according to one embodiment. In this example, the handheld device 140 is presumed to be a handheld telephone with a touch sensitive display 212. Of course, some embodiments may be adapted for use with other computing devices, including PDAs, mobile telephones, handheld video game systems, tablet computers, and other computing devices having display screens and input device(s).

As shown, the handheld device 140 includes, without limitation, a central processing unit and graphics processing unit (CPU/GPU) 205, network interfaces 215, an interconnect 220, a memory 225, and storage 230. In addition to the touch sensitive display 212, the handheld device 140 may also include a camera 214. Further, the handheld device 140 may include other input and/or output devices.

The CPU/GPU 205 retrieves and executes programming instructions stored in the memory 225. Similarly, the CPU/GPU 205 stores and retrieves application data residing in the memory 225. The interconnect 220 is used to transmit programming instructions and application data between the CPU/GPU, storage 230, network interfaces 215, and memory 225. CPU/GPU 205 is included to be representative of a single CPU, multiple CPUs, a single CPU having multiple processing cores, and the like. And the memory 225 is generally included to be representative of a random access memory. Storage 230, such as a hard disk drive or flash memory storage drive, may store non-volatile data. The camera 214 may provide a CCD device configured to capture still-images and video which may then be stored in storage 230.

Illustratively, the memory 225 includes an operating system (O/S) 226 and a healthcare support application 227. The O/S 226 provides software configured to control the execution of application programs on the handheld device. The healthcare support application 227 provides software configured to present personalized content to help users navigate a healthcare facility and provide feedback on his or her experience. For example, the healthcare support application 227 may present to the user text, links, documents, webpages, maps, images, videos, forms (e.g., patient information forms, informed consent forms, etc.), surveys, and the like which relate to one or more of diseases and therapies, caregivers, environment, emotional support, and logistics. Some content may be included in the healthcare support application 227, as downloaded and installed on the handheld device 140. Other personalized content updates may be received via, e.g., the surveillance application 106. Such personalized content may be stored in the user-specific content data 231, which is updated as new content relevant to the user is received from the surveillance application 106, and as content which is no longer relevant is removed.

It will be appreciated that the handheld device 140 shown herein is illustrative and that variations and modifications are possible. For example, the connection topology, including the number and arrangement of bridges, may be modified as desired. Further, the particular components shown herein are optional; for instance, any number of add-in cards or peripheral devices might be supported.

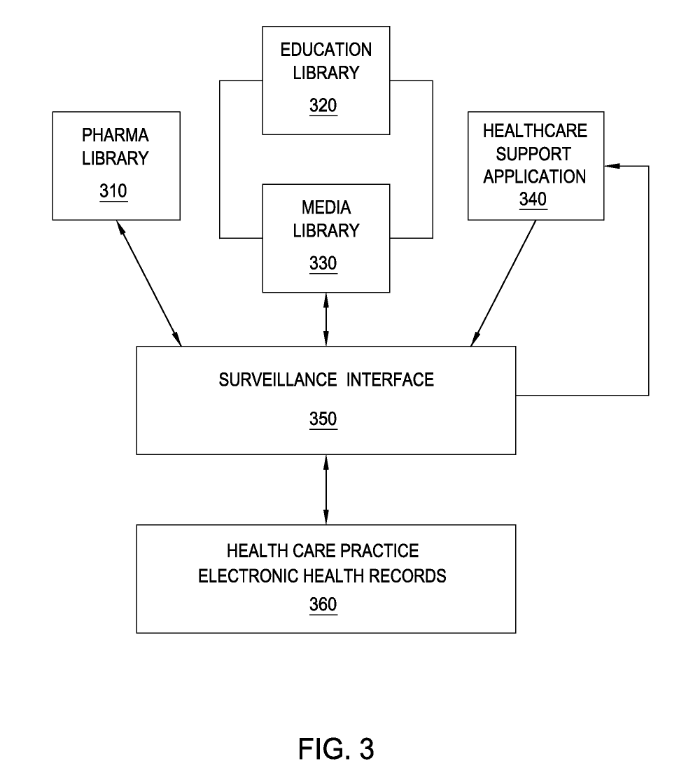

FIG. 3 illustrates relationships between components of a healthcare facility navigation system, according to an embodiment. As shown, the components include a pharmaceutical library 310, an education library 320, and a media library 330 which are accessible by a surveillance interface 350. In one embodiment, the libraries 310-330 may include content specific to one or more healthcare facilities (e.g., treatments available at particular healthcare facilities, etc.). The libraries 310-330 may also include general content. The surveillance interface 350 is further linked to electronic health records 360 of a healthcare facility, and in communication with a healthcare support application 340 running in a patient's handheld device.

The education and media libraries 310-320 are databases, digital libraries, or the like, storing content which is organized into and/or used to generate personalized content that is pushed to users' mobile devices for display via healthcare support application 340. Such content may include text, links, documents, webpages, maps, etc. stored in the education library 310, as well as associated images, videos, and other rich media stored in the media library 320. In addition, the education library 310 (or another library) may store relevant forms (e.g., patient information forms, informed consent forms, etc.), surveys, and the like which allow users to provide feedback.

In one embodiment, the content stored in the education and media libraries 310-320 may include diseases and therapies content, caregiver content, physical environment content, logistical content, emotional support content, and feedback content. Diseases and therapies content may include content which improves patient decision making by providing them with a better understanding of facts relevant to the decision making process. For example, such content may include disease states information, human anatomy information, prognosis information, information relating to treatments provided by the healthcare facility (and otherwise), treatment schedules, informed consent information and forms, among other things.

Physical environment content may include content which helps users orient themselves and understand an otherwise unfamiliar environment. For example, physical environment content may include information on how the healthcare facility operates, visiting hours, nursing stations, beds, medical equipment, among other things.

Logistical content may include content which helps users coordinate and/or implement their visits. For example, logistical content may include information on the location of a business office, schedules indicating when various events or procedures will occur, parking locations, hours of operation, among other things. The logistical content may further include off-site content relating to places to stay, restaurants, and the like. In one embodiment, the off-site content may be associated with global positioning system (GPS) coordinates, which may be used to locate the places to stay, restraurants, etc.

Caregiver content may include content which helps users understand who they are dealing with, what roles various caregivers play, to whom they should direct certain questions, among other things. For example, caregiver content may include caregiver background information, contact information, the differences between various kinds of medical practitioners (e.g., how does a resident physician differ from an attending physician), and the like.

Emotional support content may include content which provides, or allows users to find, emotional support during their visit to the healthcare facility. For example, emotional support content may include information pertaining to local places of worship; support groups for various diseases, religious affiliations, ethnicities, etc.; tools for e-mailing, messaging, or otherwise contacting support groups or places of worship; and the like.

Feedback content may include content which may be used to provide any form of feedback to the healthcare facility. For example, feedback content may include forms, surveys, event reports, e-mail and messaging tools, and the like. In one embodiment, some feedback may relate to the content that is presented via the healthcare support application itself. Such feedback may be used to, either manually or automatically, modify such content and how the content is organized and/or generated for presentation to users.

Similar to the education and media libraries 320-330, the pharmaceuticals library 310 may include educational content related to pharmaceuticals. For example, the pharmaceuticals library may include content describing the composition of various drugs, dosages, schedules for taking the drugs, among other things.

The surveillance interface 350 is configured to monitor and organize and/or generate personalized content based on a patient's electronic health records, then push such personalized content to a patient's mobile device. In one embodiment, the surveillance interface 350 may include a listening application (e.g., listening application 124), running in a healthcare facility's server, that detects changes in electronic health records and reports such changes to a surveillance application (e.g., surveillance application 106) running in an external server. In turn, the surveillance application may cross-match the reported changes with relevant content in the education, media, and pharmaceutical libraries 310-330, organize said content and/or generate new content, and push the organized and/or generated content to the healthcare support application 340. For example, a new drug may be prescribed to the patient, and an associated code entered into the EHR 126. The listening application may report this code to the surveillance application, which may in turn organize and/or generate personalized content from relevant content in the education, media, and pharmaceutical libraries 310-330. The personalized content may include, e.g., a report with text describing the new drug, periodic notifications to take the drug, and the like. The surveillance application may then push such personalized content to the patient's handheld device once, periodically, etc., as appropriate.

The healthcare support application 340 runs in the patient's handheld device and presents content to the user which is included in the application 340, as initially downloaded and installed, or which is received from the surveillance interface 350. As discussed, such content may include text, links, documents, webpages, maps, images, videos, and the like which relate to one or more of the healthcare facility's physical environment and caregivers, diseases and therapies, emotional support, and logistics. In addition, the content may include forms (e.g., patient information forms, informed consent forms, etc.), surveys, and other feedback content which the patient may complete using the healthcare support application 340.

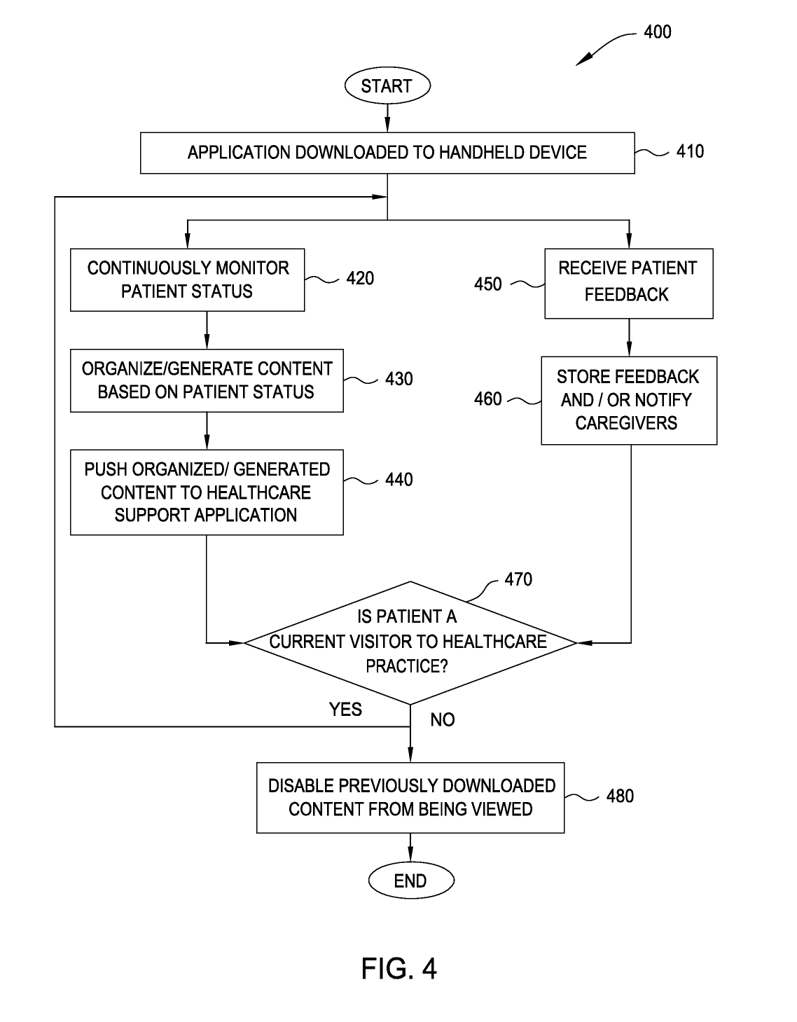

FIG. 4 illustrates a method 400 for assisting users visiting a healthcare facility, according to an embodiment. As shown, the method 400 begins at step 410, where a patient to a healthcare facility downloads a healthcare support application onto his or her handheld device. The application may be downloaded, e.g., via a wireless network provided at the healthcare facility. In one embodiment, the application may be downloaded from an online application repository, such as the Apple App Store or the Android Market Store. Of course, the application may be made available through other channels as well, such as a website administered by the healthcare facility.

At step 420, a surveillance interface continuously monitors the status of the patient. In one embodiment, the status of the patient, including the patient's diagnosis, treatment plan, medication orders, radiology and serology testing orders, etc. may be entered into electronic health records maintained on the healthcare facility's server(s). For example, ICD-10 or DRG codes may be entered into the electronic health records. A listening application installed on the healthcare facility's servers may then detect such codes being entered and report the coded entries to one or more external servers on which a surveillance application runs.

At step 430, the surveillance interface organizes and generates content based on the status of the patient. As discussed, a surveillance application may have access to education and media libraries which store various categories of content related to, e.g., diseases and therapies, caregivers, physical environment, logistical support, emotional support, and feedback. In addition, the surveillance application may have access to a pharmaceuticals library which stores content related to pharmaceuticals.

In one embodiment, the surveillance application may match received patient status data to relevant content. Continuing the example in which the surveillance application receives ICD-10 or DRG codes, the surveillance application may identify and retrieve (e.g., by executing a query against a database) content from the education, media, and pharmaceuticals libraries which relate to the received ICD-10 or DRG codes. For example, when a ICD-10 or DRG code for a new diagnosis is entered into the patient's electronic health record, the listening application may report this code to the surveillance application, which may then assemble content from the education, media, and pharmaceutical libraries 310-330 relevant to the new diagnosis. The surveillance may also generate new personalized content, such as a new content screen which includes the assembled content, or other content created based on the relevant content from the libraries 310-330, etc.

At step 440, the surveillance interface pushes the organized and generated personalized content to the patient's handheld device. In one embodiment, a surveillance application may automatically push updated content to devices of registered users. For example, reports containing text, media, etc. about a particular patient's treatment plan may regularly be pushed to that patient's handheld device as the treatment progresses. The patient may then navigate to the reports using the healthcare support application and peruse the content therein. In another embodiment, the healthcare support application may include a direct interface with the server and employ responsive web design. In yet another embodiment, the healthcare support application may periodically poll the server for updates, instead of having updates pushed to it.

Alternatively, a pull system may be implemented in which, e.g., the healthcare support application requests content for a given screen when the user navigates to that screen. For example, the user may navigate to a “Treatments” screen using the healthcare support application, and the healthcare support application may then request updated content for the “Treatments” screen. In response to this request, the surveillance application may transmit organized and/or generated content that is relevant to the patient's treatment to the patient's handheld device. In yet another embodiment, patients may be permitted to query the server storing the education and media library for content which is not directly relevant, or not yet relevant, to themselves.

Some embodiments may require the patient to log in to view content. That is, the surveillance application may receive and authenticate the patient's log in credentials before transmitting content to the patient's handheld device. No embodiments permit users to directly access protected electronic health records, and patient-specific identifiers from the electronic health record are not transmitted to the handheld device, thereby protecting patient privacy.

At step 450, the surveillance application receives patient feedback. Feedback may be provided in any technically feasible manner. In one embodiment, the healthcare support application may permit patients to view and complete surveys. In another embodiment, the healthcare support application may function as a surrogate for caregivers who typically collect information via face-to-face interactions. In such a case, the patient may populate event reports provided by the healthcare support application, and submit the event reports to the server. In yet another embodiment, the healthcare support application may include an e-mail or messaging feature for contacting particular caregivers, thereby permitting users to provide feedback, pose questions, etc. to those individuals. With such feedback, problems may be identified and resolved, or at least mitigated, as they arise. Further, caregivers are able receive real-time information about how satisfied patients are with their visits to the healthcare facility. In one embodiment, some feedback may relate to the content that is presented via the healthcare support application itself. In such a case, the feedback may be used to, either manually or automatically, modify the content presented to users and how the content is organized and/or generated by the surveillance application.

At step 460, the surveillance application stores the user feedback received at step 450 and/or notifies caregivers, as appropriate. Continuing with the examples above, survey results from various users may be stored and later compiled into reports. Meanwhile, event reports received from users may be converted to HL7 messaging standard codes and entered into the patient's electronic health record as anecdotal reports about the patient. Additionally, e-mails, messages to caregivers, and the like may be delivered to the e-mail boxes of, or otherwise transmitted to, the appropriate individuals.

At step 470, the surveillance application determines whether the user is still a current patient at the healthcare facility. Such a determination may be based on, e.g., the user's status information, including the user's electronic health records. If the user is still a current patient, then the method 400 returns to steps 430 and 450, discussed above. If, on the other hand, the server determines that the user is no longer a current patient, then the method 400 continues at step 480, where the surveillance application transmits a message to the client device to disable access to previously downloaded content. For example, the surveillance application may send an update to the healthcare support application which configures the application to only display a screen providing links and contact information for the healthcare facility, without allowing the patient to access other content.

Although described above with respect to pushing updated content based on patient status information, in alternative embodiments no such content updates may be provided. For example, the healthcare facility may be so small and specialized that all content relevant to typical patients may be included in the healthcare support application itself. In such a case, patients to the healthcare facility may simply download (and install) the application which includes all relevant content, and thereafter use the application on their handheld devices.

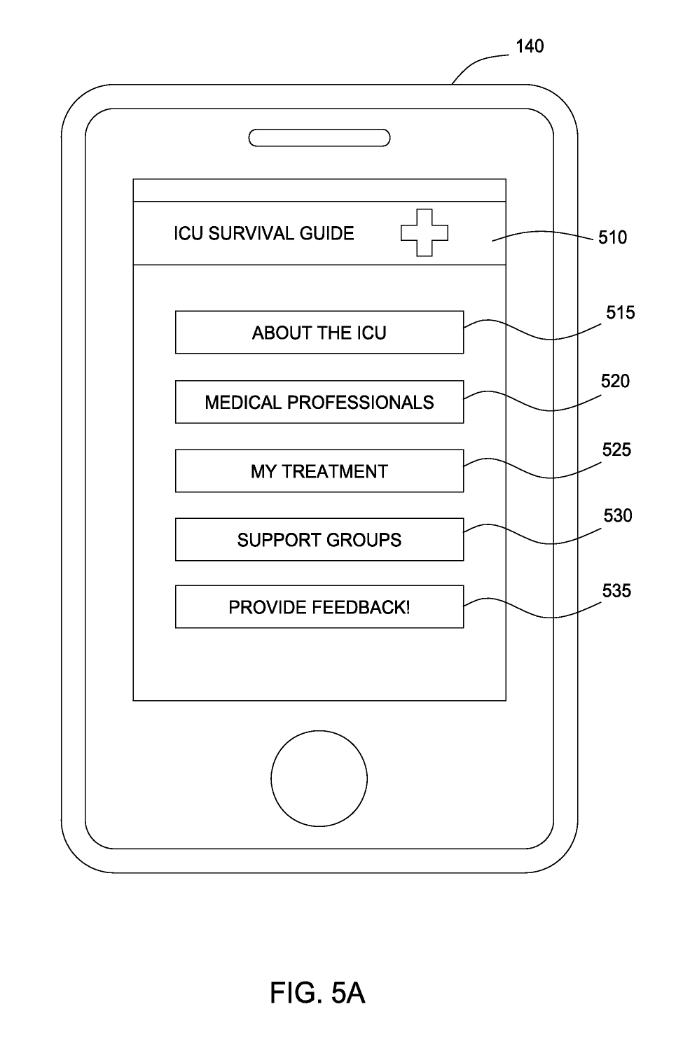

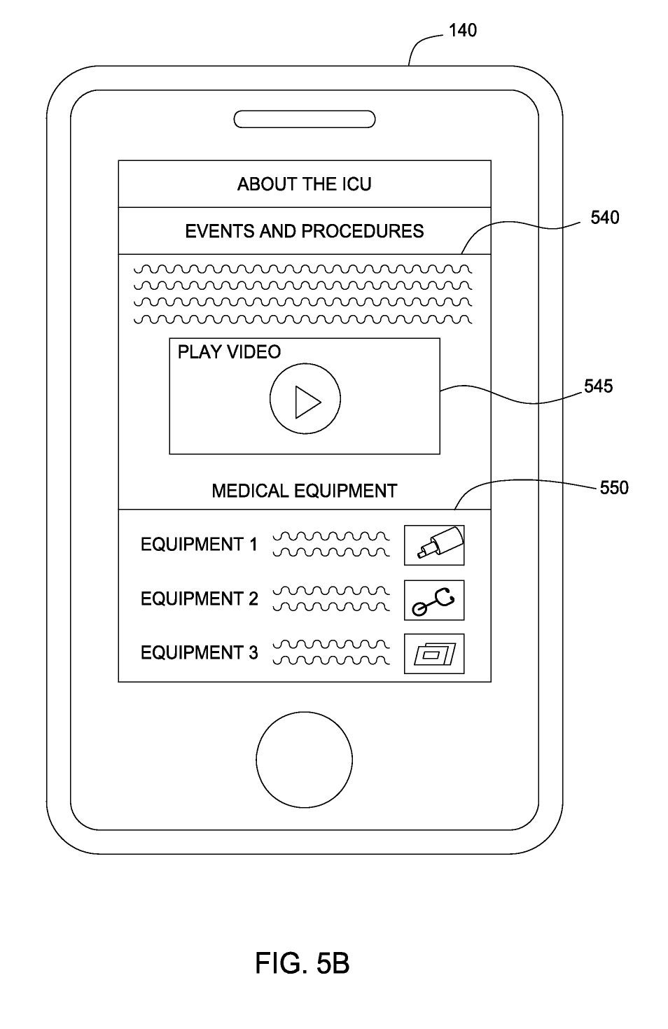

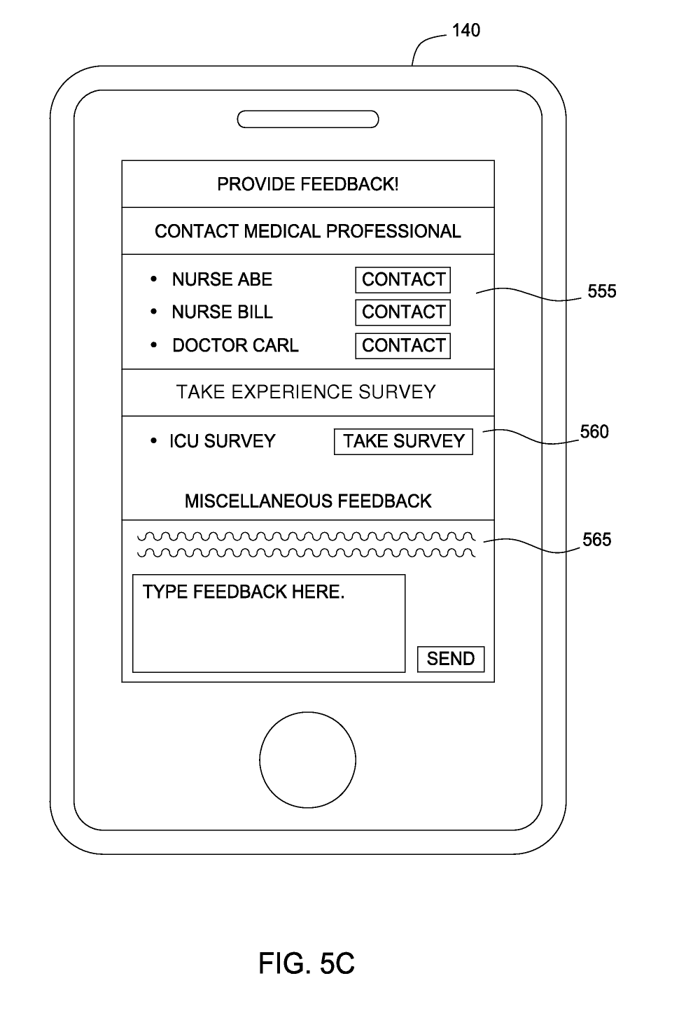

FIGS. 5A-C illustrate a variety of example screen configurations of a healthcare support application for helping users navigate healthcare facilities and provide feedback, according to one embodiment. One of ordinary skill in the art will recognize that the application screens shown in FIGS. 5A-C provide example embodiments of screens, and that such screens may be modified in a variety of ways to add, remove, and/or combine elements or otherwise be tailored for use in a particular case.

FIG. 5A illustrates an example configuration of a selection screen 510 of a healthcare support application, according to one embodiment. Illustratively, the selection screen 510 is presented on a display screen of a handheld device 140. As shown, the example selection screen 510 includes a number of buttons 515-519 for selecting further application screens relating to “About the ICU,” “Medical Professionals,” “My Treatment,” “Support Groups,” and “Provide Feedback.” As discussed, the display screen of the handheld device 140 may be a touch-screen display, and the user may select one of the buttons 515-519 by touching the screen at the displayed location of the button. In response to such a touch, the healthcare support application may cause the display screen of the handheld device 140 to present another screen associated with the selected button. Such screens may relate to, for example, the healthcare facility's physical environment and caregivers, diseases and therapies, emotional support, logistics, and/or feedback.

FIG. 5B illustrates an example configuration of a content screen 530 of the healthcare support application, according to one embodiment. As shown, the content screen 530 is presented on a display screen of handheld device 140. Illustratively, the content screen 530 includes a section entitled “Events and Procedures” having corresponding text and video 545. Here, the text may provide, for example, a schedule of times the user can expect to meet various caregivers, undergo certain procedures, etc., as well as descriptions of the caregivers, procedures, etc. The content screen 530 also includes a “Medical Equipment” section which includes text and pictures 550 relating to various medical equipment which the user may encounter during his/her visit to the healthcare facility. As discussed, content displayed to a given patient may generally include personalized text, webpages, media, etc., as well as forms (e.g., patient information forms, informed consent forms, etc.), surveys, and the like which permit user feedback. In one embodiment, the content may be organized and/or generated by a surveillance application based on the patient's electronic health records, then pushed to the patient's handheld device, according to the method 400.

FIG. 5C illustrates an example configuration of a feedback screen 552 of a healthcare support application, according to one embodiment. As shown, the feedback screen 552 is presented on a display screen of a handheld device 140. Illustratively, the feedback screen 552 includes a “Contact Medical Professional” section having text and buttons 555, which, when pressed, may cause an e-mail or messaging tool for contacting the corresponding caregiver to appear on the display screen of the device 140. The feedback screen 552 further includes a survey section 560 which includes a “Take Survey” button. In response to the patient pressing the “Take Survey” button, the healthcare support application may present a corresponding survey having, e.g., various question text, radio buttons, text boxes, etc., which the patient may complete and submit using the handheld device 140. In addition, the feedback screen 552 includes a “Miscellaneous Feedback” section 565 having a text box which the patient may type in to provide miscellaneous feedback. In another embodiment, an event report form (not shown) may be provided by the healthcare support application, and used to submit event reports to the server. As discussed, survey results, event reports, miscellaneous feedback, and the like may be stored in a server, entered into electronic health records, transmitted to relevant caregivers, etc., as appropriate.

Although discussed above with respect to navigating a healthcare facility, some embodiments may provide content for navigating multiple healthcare facilities, for navigating units within a healthcare facility, and the like. Although a patient's handheld device, electronic health records, etc. may be discussed above, techniques disclosed herein are equally applicable to visitors to healthcare facilities other than patients, such as the patients' family members or friends. That is, in some embodiments, family members and friends who download the healthcare support application may also be permitted to receive content updates related to the patient's diagnosis, treatment plan, etc., which may be tailored to those family members and friends (as opposed to the patient), as well as provide feedback.

Advantageously, embodiments disclosed herein provide, via handheld devices, a variety of content to orient patients, family members, and friends who may be unfamiliar with healthcare facilities, thereby improving healthcare decision making and providing emotional support to such patients, family members, and friends. Further, content may be updated based on user statuses such that information, resources, etc. which are specifically relevant to particular visitors to the healthcare facility are shown to those individuals. Further yet, embodiments disclosed herein permit users to provide real-time feedback to caregivers so that problems, questions, etc. may be resolved or mitigated, answered, etc. as they arise.

Various embodiments of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments and numerous specific details are set forth to provide a more thorough understanding of the invention. Persons skilled in the art, however, will understand that various modifications and changes may be made thereto without departing from the broader spirit and scope of the invention. The foregoing description and drawings are, accordingly, to be regarded in an illustrative rather than a restrictive sense.

What is claimed is:

1. A computer-implemented method for assisting a user visiting a healthcare facility, the method comprising:
continuously monitoring a status of the user visiting the healthcare facility;
organizing and/or generating personalized content relevant to the user's visit to the healthcare facility based on the monitored status of the user;
transmitting the personalized content to a handheld device of the user, wherein the content is accessible via an application configured to run on the handheld device; and
receiving and storing feedback relating to the user's visit to the healthcare facility, wherein the feedback is provided via the application.

2. The method of claim 1, wherein continuously monitoring the status of the user comprises listening for changes in electronic health records (EHR) associated with the user.

3. The method of claim 2, wherein the EHR include coded entries, and wherein the addition of coded entries to the EHR is listened to, the method further comprising:
reporting the coded entries being added, by a first server storing the EHR to a second server responsible for organizing and/or generating the personalized content.

4. The method of claim 1, wherein the personalized content relates to one or more of diseases, therapies, caregivers, physical environment, emotional support, and logistics.

5. The method of claim 1, wherein the feedback includes a populated event report, and wherein the populated event report is stored as an anecdotal report in EHR associated with the user.

6. The method of claim 1, wherein the feedback includes results of a survey about the user's visit to the healthcare facility taken by the user.

7. The method of claim 1, further comprising,
determining, based on the status of the user, whether the user is a current visitor to the healthcare facility; and
if the user is not a current visitor to the healthcare facility, disabling access to the personalized content relevant to the user's visit to the healthcare facility.

8. The method of claim 1, wherein the application is transmitted to the handheld device at a premises of the healthcare facility.

9. A computer-readable storage medium storing instructions that, when executed by a processor, cause a computer system to perform an operation for assisting a user visiting a healthcare facility, the operation comprising:
continuously monitoring a status of the user visiting the healthcare facility;
organizing and/or generating personalized content relevant to the user's visit to the healthcare facility based on the monitored status of the user;
transmitting the personalized content to a handheld device of the user, wherein the content is accessible via an application configured to run on the handheld device; and
receiving and storing feedback relating to the user's visit to the healthcare facility, wherein the feedback is provided via the application.

10. The computer-readable storage medium of claim 9, wherein continuously monitoring the status of the user comprises listening for changes in electronic health records (EHR) associated with the user.

11. The computer-readable storage medium of claim 10, wherein the EHR include coded entries, and wherein the addition of coded entries to the EHR is listened to, the operations further comprising:
reporting the coded entries being added, by a first server storing the EHR to a second server responsible for organizing and/or generating the personalized content.

12. The computer-readable storage medium of claim 9, wherein the personalized content relates to one or more of diseases, therapies, caregivers, physical environment, emotional support, and logistics.

13. The computer-readable storage medium of claim 9, wherein the feedback includes a populated event report, and wherein the populated event report is stored as an anecdotal report in EHR associated with the user.

14. The computer-readable storage medium of claim 9, wherein the feedback includes results of a survey about the user's visit to the healthcare facility taken by the user.

15. The computer-readable storage medium of claim 9, the operations further comprising,
determining, based on the status of the user, whether the user is a current visitor to the healthcare facility; and
if the user is not a current visitor to the healthcare facility, disabling access to the personalized content relevant to the user's visit to the healthcare facility.

16. The computer-readable storage medium of claim 9, wherein the application is transmitted to the handheld device at a premises of the healthcare facility.

17. A system, comprising:
a processor; and
a memory configured to perform an operation for assisting a user visiting a healthcare facility, the operation comprising:
continuously monitoring a status of the user visiting the healthcare facility,
organizing and/or generating personalized content relevant to the user's visit to the healthcare facility based on the monitored status of the user,
transmitting the personalized content to a handheld device of the user, wherein the content is accessible via an application configured to run on the handheld device, and
receiving and storing feedback relating to the user's visit to the healthcare facility, wherein the feedback is provided via the application.

18. The system of claim 17, wherein continuously monitoring the status of the user comprises listening for changes in electronic health records (EHR) associated with the user.

19. The system of claim 18, wherein the EHR include coded entries, and wherein the addition of coded entries to the EHR is listened to, the method further comprising:
reporting the coded entries being added, by a first server storing the EHR to a second server responsible for organizing and/or generating the personalized content.

20. The system of claim 18, wherein the personalized content relates to one or more of diseases, therapies, caregivers, physical environment, emotional support, and logistics.
